(19) United States
(12) Patent Application Publication
(10) Pub. No.: US 2003/0179783 A1
(43) Pub. Date: Sep. 25, 2003

(54) Wavelength division multiplexing transmission system

(75) Inventors: Kimio Uekama, Kawasaki (JP); Yukako Yoita, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/269,081

(22) Filed: Oct. 11, 2002

(30) Foreign Application Priority Data
Mar. 20, 2002 (JP) 2002-078053

(51) Int. Cl. H04J 3/04

(52) U.S. Cl. 370/535

(57) ABSTRACT

In a time division multiplexer, a time division demultiplexer, a time division multiplexing wavelength converter, and a time division demultiplexing wavelength converter, a time division multiplexing portion in a time division multiplexer converts a plurality of frames having the first format into time division multiplexed data, and an encoder mounts the data on frames of the second format to be outputted to a single line. A decoder in a time division demultiplexer decodes the frames from the time division multiplexer, and a time division demultiplexing portion demultiplexes a plurality of frames of the first format from the data.

### BACKGROUND OF THE INVENTION

1. Field of the Invention

The present invention relates to a wavelength division multiplexing (WDM) transmission system, and in particular to a wavelength division multiplexing transmission system employing a time division multiplexer, a time division demultiplexer, a time division multiplexing wavelength converter, and a time division demultiplexing wavelength converter.

In recent years, as computers have become more powerful and communication has become multimedia-capable, information of various media such as voice, data, or images to be transmitted has been increasing. In order to accommodate to such increasing transmission information, backbone networks have grown in capacity. In the backbone networks, e.g. an SDH/SONET time division multiplexing system, and a wavelength division multiplexing transmission system, which transmits large-capacity information by passing a plurality of lights of different wavelengths through an optical cable, are important.

2. Description of the Related Art

FIG. 9 shows an example of a general wavelength division multiplexing transmission system, where input terminal stations 41_1 and 41_2 multiplex OC-48 SONET signals inputted from lines (channels) ch1-ch4 into OC-192 SONET signals of a wavelength f0 by a SONET format.

Input terminal stations 41_3 and 41_4 (hereinafter, input terminal stations 41_3, and 41_4, as well as 41_1 and 41_2 are occasionally represented by a reference numeral 41) multiplex OC-12 SONET signals inputted from lines ch1-ch16 into the OC-192 SONET signals of the wavelength f0 by the SONET format. These OC-192 SONET signals are converted by wavelength converters 11_1-11_4 (hereinafter, occasionally represented by a reference numeral 11) into optical SONET signals of wavelengths fl-f4 different from each other, and then the converted SONET signals are provided to a wavelength division multiplexer 13 through variable attenuators (VAT's) 12.

The wavelength division multiplexer 13 wavelength division multiplexes the OC-192 SONET signals of the wavelengths f1-f4. Hereinafter, the verb “wavelength division multiplex” will be occasionally abbreviated as --multiplex--. The multiplexed optical signals are transmitted to a wavelength division demultiplexer 22 through a transmission amplifier 14, relays (amplifiers) 30_1-30_n, and a reception amplifier 23.

It is to be noted that the transmission amplifier 14 is controlled by booster units (BST's) 16, and the VAT's 12 are controlled by an analysis result of a spectrum analyzer unit (SAU) 15 analyzing a light of the transmission amplifier 14.

The wavelength division demultiplexer 22 wavelength division demultiplexes the optical signal into the OC-192 SONET signals of the wavelengths f1-f4 to be respectively provided to wavelength converters 21_1-21_4. Hereinafter, the verb “wavelength division demultiplex” will be occasionally abbreviated as --demultiplex--. The wavelength converters 21_1-21_4 respectively convert the OC-192 SONET signals of the wavelengths f1-f4 into the OC-192 SONET signals of the wavelength f0 to be provided to output terminal stations 42_1-42_4.

The output terminal stations 42_1 and 42_2 time division demultiplex the OC-192 SONET signals into the OC-48 SONET signals to the lines ch1-ch4 by the SONET format to be outputted. Hereinafter, the verb “time division demultiplex” will be occasionally abbreviated as --demultiplex--. The output terminal stations 42_3 and 42_4 demultiplex the OC-192 SONET signals into the OC-12 SONET signals to the lines ch1-ch16 to be outputted.

Thus, wavelength multiplexing in the wavelength division multiplexing system is realized by multiplexing input optical signals of predetermined wavelengths slightly different from each other. When the input optical signals are not the predetermined wavelengths, a wavelength conversion into wavelengths which can be multiplexed by using the wavelength converter 11 is required.

Also, the number of wavelengths which can be multiplexed is limited by the number of input ports of the wavelength division multiplexer 13. Also, in order to transmit at the maximum transmission rate available for each wavelength, e.g. OC-192, it is required for the input terminal station 41 to time division multiplex e.g. the inputted OC-3, OC-12, and OC-48 SONET signals into the SONET signals of the maximum transmission rate OC-192 in accordance with the SONET format, and to provide the multiplexed SONET signals to the input ports of the wavelength division multiplexer 13 through the wavelength converter 11. Hereinafter, the verb “time division multiplex” will be occasionally abbreviated as --multiplex--.

FIG. 10A shows an arrangement of a time division multiplexer included in the input terminal station 41 of FIG. 9. FIG. 10B shows an arrangement of a time division demultiplexer included in the output terminal station 42.

In FIG. 10A, the time division multiplexer receives e.g. the OC-12 SONET signal opto-electric (O/E)-converted e.g. by an O/E converter at a former stage of its own time division multiplexer, and multiplexes the received OC-12 SONET signal into e.g. the OC-192 SONET signal in accordance with the SONET format to be outputted. Hereinafter, the verb “O/E convert” will be occasionally abbreviated as --convert--. An E/O converter 170a converts an OC-192 electrical signal into an OC-192 optical signal of the wavelength f0.

Generally, the wavelengths of the OC-192 optical signals outputted from the input terminal stations 41_1-41_4 (see FIG. 9) are the same wavelength f0.

It is to be noted that the input signal provided to the input terminal station 41_3 is e.g. the OC-12 SONET signal, and the transmission rate which can be received is fixed, so that the input terminal station 41_3 does not accommodate to e.g. the OC-3 or OC-48 signal.

The operation of the time division multiplexer in the input terminal station 41_3 will now be described referring to FIG. 10A.

The time division multiplexer is provided with 16 frame receivers 103_1-103_16 (hereinafter, occasionally represented by a reference numeral 103) receiving the OC-12 SONET signals, and a SONET multiplexing portion 510 for multiplexing the OC-12 SONET signals from the frame receivers 103 into the OC-192 SONET signal on the output side by the SONET format.

Furthermore, the time division multiplexer is provided with a BIP (Bit Interleaved Parity) generator 511, a scrambler 512, and a parity generator 513.

The frame receiver 103 includes a clock loss detector 501, an LOS (Loss of Signal) detector 502, a parity detector 503, a frame synchronizer 504, an overhead (OH) terminator 506, a descrambler 505, and a pointer changer 508.

The frame receiver 103 extracts a line clock 155 MHz from the inputted OC-12 SONET signal. When the frame receiver 103 fails in the clock extraction, the clock loss detector 501 detects the failure to output a clock loss signal. Also, the frame receiver 103 detects the SONET signal based on the detected clock. When the frame receiver 103 fails in a signal detection, the LOS detector 502 outputs an LOS (Loss of Signal) signal.

The frame synchronizer 504 detects a SONET frame based on a synchronization signal included in the SONET signal. The parity detector 503 performs a parity detection before descrambling. The descrambler 505 descrambles a predetermined field of the SONET frame.

The OH terminator 506 terminates an overhead included in a frame. Data included in a payload field of the frame are synchronized with the line clock 155 MHz to be read in an FIFO (First in First out) memory 507.

The data read in the FIFO memory 507 is read out in synchronization with a master clock 155 MHz on the side of the time division multiplexer. Then the pointer is changed to one (designating a stuff corresponding to a head position of data for OC-192 frame and a phase variation of a line clock and a master clock) corresponding to the OC-192 SONET frame by the pointer changer 508. The data and the pointer are provided to the SONET multiplexing portion 510.

The SONET multiplexing portion 510 multiplexes the data and the pointer from each frame receiver 103 respectively into the payload field and an overhead field of the SONET frame on the time division multiplexer side by a byte interleave method in accordance with the SONET format.

The BIP generator 511 and the parity generator 513, in accordance with the SONET format, generate a BIP to be set in the overhead of the OC-192 SONET frame on the output side. In addition to the BIP, a frame synchronization signal and bytes of various operational functions such as an alarm generation state indication and a transmission line switchover control are set in the overhead.

The scrambler 512 scrambles a predetermined field within the OC-192 frame.

The operation of the time division demultiplexer in the output terminal station 42 in FIG. 10B will now be described.

The time division demultiplexer includes functional portions for terminating e.g. the received OC-192 (or OC-48) SONET frame, i.e. a clock loss detector 601, an LOS (Loss of Signal) detector 602, a parity detector 603, a frame synchronizer 604, a descrambler 605, and an OH terminator 606.

Also, the time division demultiplexer includes an elastic store memory 607 for changing the clock from the line clock 155 MHz to the master clock 155 MHz within the time division demultiplexer, a SONET demultiplexing portion 610 for demultiplexing the terminated frame into e.g. OC-48, OC-12, or OC-3 frames in accordance with the SONET format, and 16 frame transmitters 203_1-203_16 (hereinafter, occasionally represented by a reference numeral 203) for generating the overhead in the demultiplexed frames.

The frame transmitter 203 includes an OH inserter 611, a scrambler 612, and a parity generator 613.

The functional portion for terminating the OC-192 frame extracts the line clock from the OC-192 SONET signal. When the functional portion fails in the clock extraction, the clock loss detector 601 outputs the clock loss signal. Also, the functional portion for terminating the frame detects the SONET signal in synchronization with the extracted clock. When the functional portion fails in the signal detection, the LOS detector 602 outputs the LOS signal.

The frame synchronizer 604 performs a frame synchronization of the detected signal. The parity detector 603 performs a parity check of the frame before descrambling. The descrambler 605 descrambles a predetermined field within the frame. The OH terminator 606 terminates the overhead within the OC-192 frame.

The data of the payload field within the OC-192 frame are synchronized with the line clock to be read in the elastic store memory 607.

The SONET demultiplexing portion 610 reads out the data written in the memory 607 in synchronization with the master clock on the time division demultiplexer side. The read data are demultiplexed in accordance with the SONET format to be provided to the 16 frame transmitters 203.

The frame transmitter 203, in accordance with the SONET format, inserts the received data into the payload field of the OC-12 frame on the transmission side. The OH inserter 611 inserts the overhead. The scrambler 612 scrambles a predetermined field. The parity generator 613 generates a parity to be added to a predetermined position of the overhead.

In such a prior art WDM system, the time division multiplexer of the input terminal station 41 on the transmission side multiplexes the input SONET signal in accordance with the SONET format for the transmission. The time division demultiplexer of the output terminal station 42 on the reception side demultiplexes the received signal in accordance with the SONET format.

Also, the time division multiplexing/demultiplexing by the SONET format is also intended for the transmission line, between the input terminal station 41 and the output terminal station 42, not requiring an overhead processing, e.g. system operational processing such as an alarm generation state indication and a transmission line switchover control, which has resulted in a complicated arrangement of the time division multiplexer/demultiplexer.

Also, the number of wavelengths which can be wavelength multiplexed in the wavelength division multiplexer 13 (see FIG. 9) is limited to the number of input ports of the wavelength division multiplexer 13. Therefore, in order to use each wavelength at the maximum transmission rate which can be transmitted, it has been required for the input terminal station to multiplex the input signal into the maximum rate.

Also, when the signals inputted to the input terminal station 41 have the transmission rates, e.g. OC-3, OC-12, OC-48, and the like, it has been required to prepare the input terminal station 41 corresponding to the respective transmission rates.

### SUMMARY OF THE INVENTION

It is accordingly an object of the present invention to provide, in a wavelength division multiplexing transmission system, a time division multiplexer, a time division demultiplexer, a time division multiplexing wavelength converter, and a time division demultiplexing wavelength converter, wherein only processing required for a signal transmission is performed without performing overhead processing of an individual frame format, and time division multiplexing which accommodates to input signals of different transmission rates is realized.

In order to achieve the above-mentioned object, a time division multiplexer according to the present invention comprises: a time division multiplexing portion for converting frames having a first format respectively received from a plurality of lines into time division multiplexed data; and an encoder for mounting (mapping) the data on one or more frames of a second format to be outputted to a single line (claim 1).

Namely, a time division multiplexing portion receives frames of the first format, e.g. OC-12 SONET frames (claim 2) respectively from a plurality of lines. Phases of the SONET frames received at this time may be the same or different from each other.

The time division multiplexing portion converts a plurality of OC-12 SONET frames including an overhead into time division multiplexed data. An encoder mounts the data on the frames of the second format, e.g. frames of an FEC format (claim 3) to be outputted from a single line.

At this time, the phases of the OC-12 frame and the FEC frame may be the same or different from each other. The time division multiplexed OC-12 frame may be mounted on a single FEC frame, or on two or more frames.

Thus, it becomes possible to easily multiplex the frames from a plurality of lines to be mounted on another frame for a transmission. Since the time division multiplexing portion need not perform overhead processing of the first frame, i.e. operational processing such as an alarm generation state indication and a transmission line switchover control, a circuit can be downsized.

Also, the above-mentioned multiplexing may comprise bit multiplexing (claim 4).

Also, the present invention, according to the above-mentioned present invention, may further comprise a clock/data recovery portion for receiving frames of different predetermined transmission rates and for recovering a clock and data to be outputted to the time division multiplexing portion (claim 5).

Namely, a clock/data recovery portion can receive frames of different transmission rates, e.g. OC-3, OC-12, or OC-48 frames. The time division multiplexing portion multiplexes e.g. the OC-12 frames from a plurality of recovery portions.

Thus, the time division multiplexer can accommodate to the frames of the first format of different transmission rates. Namely, the time division multiplexer can receive e.g. a plurality of OC-3 frames, a plurality of OC-12 frames, a plurality of OC-48 frames, or mixed frames in which OC-3 frames and OC-12 frames coexist.

As a result, the time division multiplexer can provide commonality among the frames of different transmission rates. Namely, the frame reception of a plurality of transmission rates by e.g. the same card can be realized.

Also, the above-mentioned first format may have a hierarchized format so that the frames of different hierarchies coexist (claim 6).

Namely, the first format is a hierarchized format such as an OC-3 frame, an OC-12 frame, an OC-48 frame of an SDH/SONET format. In a plurality of frames, e.g. the OC-12 and OC-48 frames can coexist.

Also, the present invention, according to the above-mentioned present invention, may further comprise a receiving processor for performing an error detection, an error correction, or descrambling of the frames of the first format (claim 7).

Namely, when an error detection code or an error correction code is included in the frame of the first format, a receiving processor can perform an error detection or error correction. When the frame of the first format is scrambled, the receiving processor can descramble the frame.

Thus, the time division multiplexer can accommodate to the error detection or the correction processing of the frame of the first format, or to the first frame including the scrambling.

Also, in order to achieve the above-mentioned object, a time division demultiplexer according to the present invention comprises: a decoder for decoding frames having a second format on which time division multiplexed data of a plurality of frames having a first format are mounted; and a time division demultiplexing portion for time division demultiplexing a plurality of frames of the first format from the data (claim 8).

Namely, a decoder decodes the data from the frames of the second format. A time division demultiplexing portion demultiplexes the multiplexed frame of the first format.

Thus, it becomes possible to easily demultiplex a plurality of frames of the first format multiplexed from the frames of the second format.

Also, the above-mentioned first format may comprise an SDH/SONET format (claim 9).

Also, the above-mentioned second format may comprise an FEC (Forward Error Correction) format (claim 10).

Also, the above-mentioned time division multiplexing may comprise bit multiplexing (claim 11).

Also, in order to achieve the above-mentioned object, a time division multiplexing wavelength converter according to the present invention comprises: a plurality of O/E converters for converting frames, which are predetermined wavelength optical signals having a first format, respectively received from a plurality of lines into electrical signals; a time division multiplexing portion for converting a plurality of frames of the electrical signals into time division multiplexed data; an encoder for mounting the data on one or more frames of a second format to be outputted to a single line; and an E/O converter for converting the frames of the second format into optical signals of a wavelength different from the predetermined wavelength (claim 12).

Namely, a time division multiplexing wavelength converter of the present invention is provided with an O/E converter and an E/O converter respectively at a former stage and a subsequent stage of the time division multiplexer of the above-mentioned present invention. This E/O converter converts an electrical signal into an optical signal whose wavelength is different from that of the optical signal on the input side.

Thus, it becomes possible, for example, to input optical signals, different from each other, outputted from a plurality of time division multiplexing wavelength converters of the present invention to a wavelength division multiplexer.

Also, the transmission rate of the signal inputted to the wavelength division multiplexer can be multiplexed into the maximum transmission rate which can be transmitted by the wavelength division multiplexer on the time division multiplexing wavelength converter side, so that it becomes unnecessary to maximize the transmission rate on the input terminal station side.

Also, the present invention, according to the above-mentioned present invention, may further comprise a clock/data recovery portion for receiving electrical signal frames of different predetermined transmission rates and for recovering a clock and data to be outputted to the time division multiplexing portion (claim 13).

The time division multiplexing wavelength converter has a time division multiplexing/demultiplexing function and a clock/data recovery function by which a plurality of transmission rates can be received, thereby enabling the time division multiplexer on the input terminal station side to be reduced in number.

Furthermore, in order to achieve the above-mentioned object, a time division demultiplexing wavelength converter according to the present invention comprises: an O/E converter for converting, into electrical signals, frames which are predetermined wavelength optical signals having a second format on which time division multiplexed data of a plurality of frames having a first format are mounted; a decoder for decoding the frames of the second format; a time division demultiplexing portion for time division demultiplexing a plurality of frames of the first format from the data; and an E/O converter for converting electrical signals of a plurality of frames of the first format into optical signals of a wavelength different from the predetermined wavelength (claim 14).

Namely, the time division demultiplexing wavelength converter of the present invention is provided with an O/E converter and an E/O converter respectively at a former stage and a subsequent stage of the above-mentioned time division demultiplexer. The E/O converter converts an electrical signal into an optical signal whose wavelength different from that of the optical signal on the input side.

Thus, it becomes possible to demultiplex the time division multiplexed data received from e.g. a wavelength division demultiplexer, and to convert the wavelength of the inputted optical signal into another wavelength.

### BRIEF DESCRIPTION OF THE DRAWINGS

The above and other objects and advantages of the invention will be apparent upon consideration of the following detailed description, taken in conjunction with the accompanying drawings, in which the reference numbers refer to like parts throughout and in which:

FIG. 1 is a block diagram showing an embodiment of a time division multiplexer according to the present invention;

FIG. 2 is a block diagram showing an embodiment of a clock/data recovery portion in a time division multiplexer according to the present invention;

FIGS. 3A and 3B are block diagrams showing an internal general function of a time division multiplexer and a time division demultiplexer according to the present invention for each composed of an LSI;

FIGS. 4A and 4B are diagrams showing an arrangement of an FEC frame used in a time division multiplexer and a time division demultiplexer according to the present invention;

FIGS. 5A-5G are diagrams showing an interface of an FEC frame used in a time division multiplexer and a time division demultiplexer according to the present invention;

FIG. 6 is a block diagram showing an embodiment of a time division demultiplexer according to the present invention;

FIG. 7 is a block diagram showing an embodiment of a wavelength division multiplexing system using a time division multiplexing wavelength converter and a time division demultiplexing wavelength converter according to the present invention;

FIG. 8 is a block diagram showing another embodiment of a wavelength division multiplexing system using a time division multiplexing wavelength converter and a time division demultiplexing wavelength converter according to the present invention;

FIG. 9 is a block diagram showing an example of a prior art wavelength division multiplexing network; and

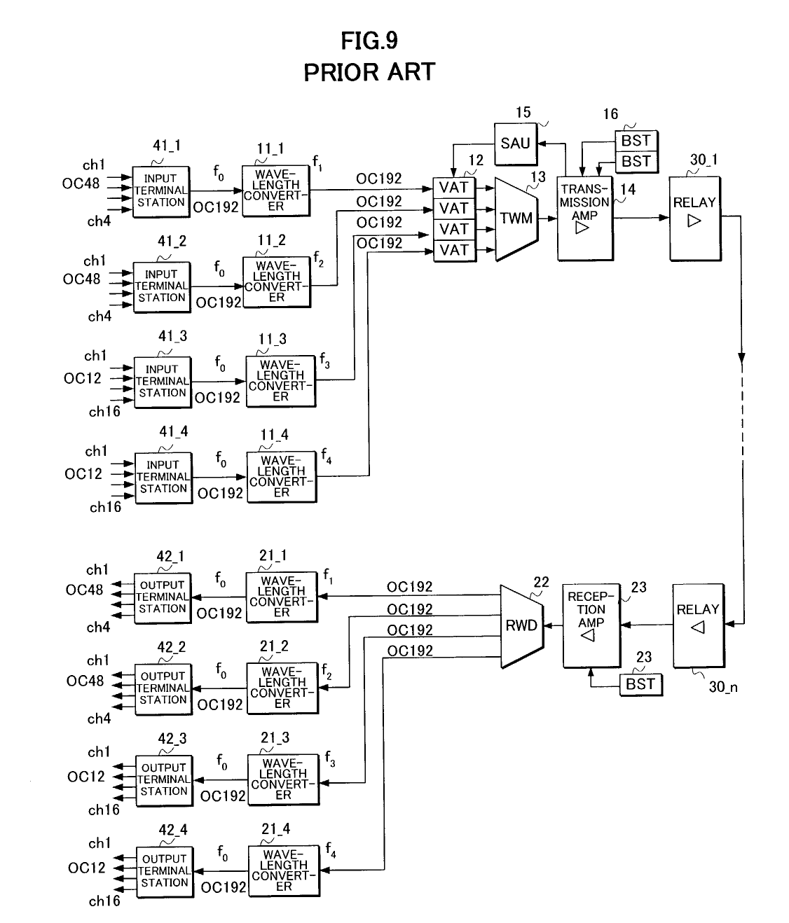

FIGS. 10A and 10B are block diagrams showing an internal general function of prior art time division multiplexer and time division demultiplexer for each composed of an LSI.

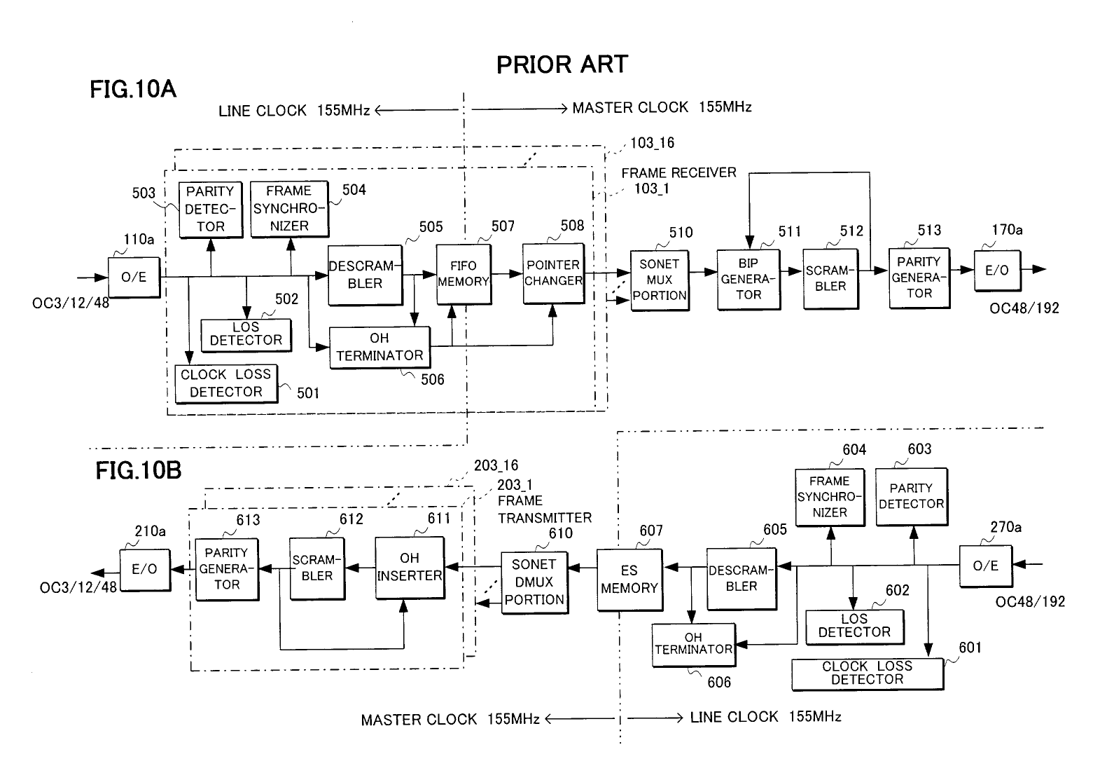

### DESCRIPTION OF THE EMBODIMENTS

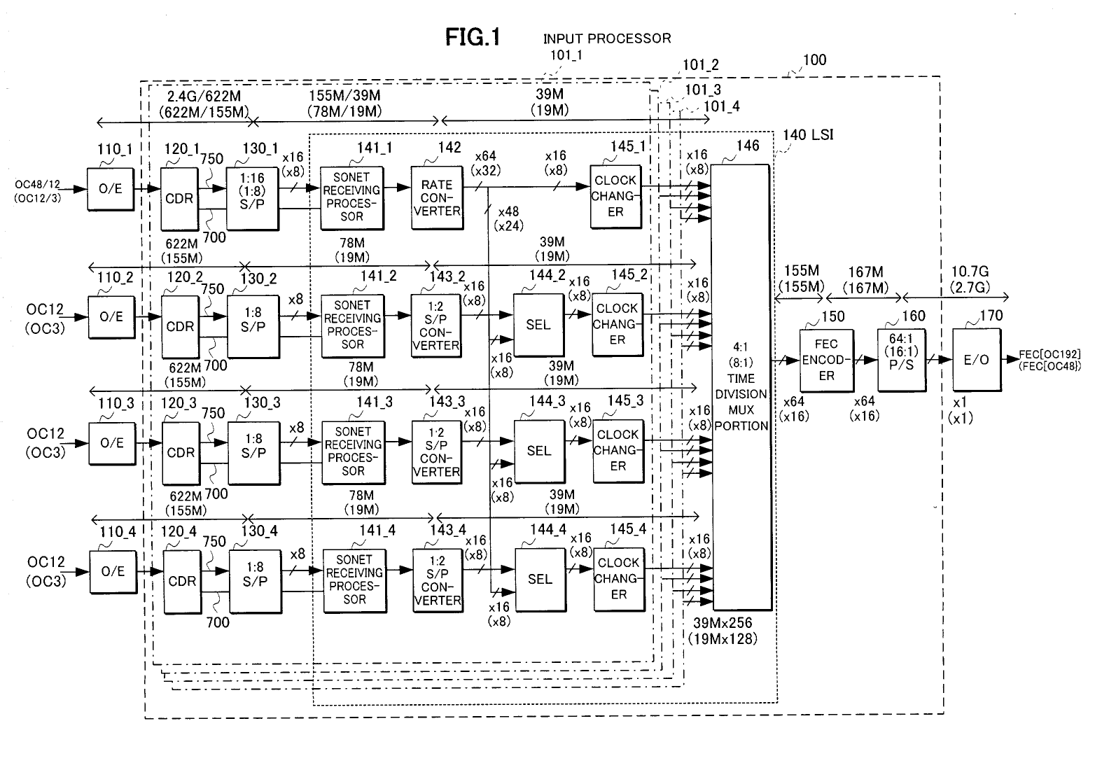

FIG. 1 shows an embodiment of a time division multiplexer 100 of the present invention. This time division multiplexer 100 is composed of input processors 101_1-101_4 (hereinafter, occasionally represented by a reference numeral 101) for respectively receiving and processing SONET signals on 4 lines, a time division multiplexing portion 146, an FEC encoder 150, and a P/S converter 160. The time division multiplexer 100 multiplexes the SONET signals on 16 lines at the maximum into an FEC frame on a single line.

Each of the input processors 101 is provided with a function of receiving and processing the OC-48 or OC-12 SONET signal on a single line, as well as a function of receiving and processing the OC-12 SONET signals on 3 lines. This arrangement enables the time division multiplexer 100 to multiplex the inputted OC-12 SONET signals on 16 lines, the OC-48 SONET signal on a single line and the OC-12 SONET signals on 12 lines, the OC-48 SONET signals on 2 lines and the OC-12 SONET signals on 8 lines, the OC-48 SONET signals on 3 lines and the OC-12 SONET signals on 4 lines, or the OC-48 SONET signals on 4 lines, to be transmitted by the FEC frame on a single line corresponding to the transmission rate of OC-192.

It is to be noted that values in parentheses in FIG. 1 indicate an embodiment in which the time division multiplexer 100 multiplexes the OC-12 or OC-3 SONET signal into the FEC frame corresponding to the transmission rate of OC-48 to be transmitted.

In this case, each of the input processors 101 is provided with a function of receiving and processing the OC-12 or OC-3 SONET signal on a single line, as well as a function of receiving and processing the OC-3 SONET signal on 3 lines. The combination of the OC-12 SONET signal and the OC-3 SONET signal which can be multiplexed by the time division multiplexer 100 is the same as that for the above-mentioned OC-48 SONET signal and the OC-12 SONET signal being respectively assumed to be the OC-12 SONET signal and the OC-3 SONET signal.

In either case, since the transmission rates of the inputted SONET signal and the outputted FEC frame are different from each other, only the timing of the time division multiplexing is different in the basic operation of the time division multiplexer 100 and other operations are the same.

Hereinafter, the case where the OC-48 and OC-12 SONET signals are multiplexed into the FEC frame will be mainly described, and the case where the OC-12 and OC-3 SONET signals are multiplexed into the FEC frame will be described as appropriate.

Each of the input processors 101 includes a clock/data recovery (CDR) portion 120_1 for extracting a clock from the OC-48 or OC-12 SONET signal and for recovering the SONET signal, an S/P converter 130_1 for serial/parallel converting recovered data (SONET signal) at a ratio of 1:16 or 1:8, a SONET receiving processor 141_1 for receiving and processing the converted parallel data, a rate converter 142 for converting the rate of the processed data, and a clock changer 145_1. Hereinafter, the verb “serial/parallel convert” will be occasionally abbreviated as --convert--.

Furthermore, each of the input processors 101 respectively includes clock/data recovery portions 120_2-120_4 (hereinafter, reference numerals 120_1-120_4 are occasionally represented by a reference numeral 120) corresponding to the OC-12 SONET signals, S/P converters 130_2-130_4 (hereinafter, reference numerals 130_1-130_4 are occasionally represented by a reference numeral 130) for converting at a ratio of 1:8, SONET receiving processors 141_2-141_4 (hereinafter, processors 141_1-141_4 are occasionally represented by a reference numeral 141), S/P converters 143_2-143_4 (hereinafter, occasionally represented by a reference numeral 143) for converting the data processed at the receiving processor 141 at a ratio of 1:1 unchanged or 1:2, selectors 144_2-144_4 (hereinafter, occasionally represented by a reference numeral 144) for selecting either of the data from the rate converter 142 or the data from the S/P converter 143, and clock changers 145_2-145_4 (hereinafter, reference numerals 145_1-145_4 are occasionally represented by a reference numeral 145).

It is to be noted that the SONET receiving processors 141_1-141_4, the rate converter 142, the S/P converters 143_2-143_4, the selectors 144_2-144_4, the clock changers 145_1-145_4, and the time division multiplexing portion 146 in each of the input processors 101_1-101_4 are composed of an LSI 140.

Hereinafter, the operation will now be described in which the time division multiplexer 100 transmits the OC-48 SONET signal on a single line inputted to the input processor 101_1 and the OC-12 SONET signals on 12 lines inputted to the input processors 101_2-101_4, into form of the FEC frame on a single line corresponding to the transmission rate of OC-192.

The OC-48 and OC-12 optical SONET signals are respectively converted by O/E converters 110_1, 110_5-110_16 (O/E converters 110_5-110_16 corresponding to the input processors 101_2-101_4 are not shown). Then, the electric OC-48 and OC-12 SONET signals are inputted to the time division multiplexer 100. Also, the output signal (FEC frame) of the time division multiplexer 100 is E/O-converted by an E/O converter 170. Hereinafter, the verb “E/O convert” will be occasionally abbreviated as --convert--.

The CDR 120_1 of the input processor 101_1 is set to receive the OC-48 SONET signal, and the CDR's 120_2-120_4 of the input processor 101_1 and the CDR's 120_1-120_4 of the input processors 101_2-101_4 are set to receive the OC-12 SONET signal. It is to be noted that hereinafter, the reference numerals of the CDR's 120_1-120_4 are occasionally represented by a reference numeral 120.

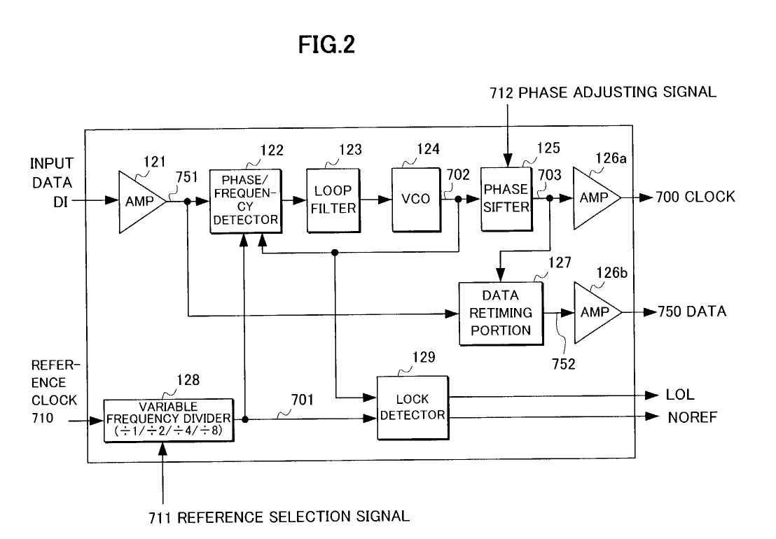

FIG. 2 shows an arrangement of the CDR 120. This CDR 120 extracts a line clock from the received OC-48, OC-12, or OC-3 SONET signal, and recovers the SONET signal. Which of OC-48, OC-12, or OC-3 is the recovered SONET signal is determined by settings of a frequency of a reference clock 710 and a reference selection signal 711 inputted to the CDR 120.

It is to be noted that the settings of the CDR 120 can be performed by determining the transmission rate of the SONET signal automatically based on the frequency of the input signal detected by the CDR 120 itself.

The CDR 120 includes an amplifier 121 for amplifying the inputted SONET signal (=input data DI), a PLL portion composed of a phase/frequency detector 122, a loop filter 123, a voltage controlled oscillator (VCO) 124, a phase shifter 125 for outputting a clock 703 that is a clock 702 extracted at the PLL portion and phase shifted based on a phase adjusting signal 712, and an amplifier 126a for outputting a clock 700 that is the clock 703 amplified.

Also, the CDR 120 includes a data retiming portion 127 for retiming a SONET signal 751 amplified by the amplifier 121 with the extracted clock 703, an amplifier 126b for amplifying a SONET signal 752 retimed to output a SONET signal 750, a variable frequency divider 128 for inputting the reference clock 710 and the reference selection signal 711 to provide a clock 701 of a predetermined frequency to the phase/frequency detector 122, and a lock detector 129 for inputting the clocks 701 and 702 and for outputting a signal LOL indicating a failure of the clock extraction, and a signal NOREF indicating whether the reference clock 710 is not inputted or the frequency of the extracted clock 702 is outside a predetermined frequency.

In FIG. 1, the CDR 120_1 recovers the clock 700 and the SONET signal 750 from the OC-48 SONET signal (2.4 Gbps) received through the O/E converter 110_1 of the input processor 101_1. The S/P converter 130_1 converts the SONET signal 750 at a ratio of 1:16 to be provided to the SONET receiving processor 141_1.

At this time, the transmission rate per bit of a 16-bit parallel SONET signal is 155 Mbps (≈2.4 Gbps÷16).

The SONET receiving processor 141_1 performs the receiving processing of the 16-bit parallel SONET signal, for example, processing of a frame synchronization, an OH termination, descrambling, an error code correction, or the like, and then provides the SONET signal to the rate converter 142 with the OC-48 frame of the SONET signal being maintained. The rate converter 142 converts the rate of the SONET signal into a 64-bit parallel SONET signal to be outputted. The transmission rate per bit at this time is 39 Mbps (≈155 Mbps÷4).

A single set of 16-bit SONET signal within the 64-bit parallel SONET signal is directly forwarded to the clock changer 145_1, and the other three sets of 16-bit SONET signals are respectively selected at the selectors 144_2-144_4 to be provided to the clock changers 145_2-145_4.

It is to be noted that in case where the input processor 101_1 performs the input processing to the OC-48 SONET signal, other three OC-12 SONET signals are not inputted. Accordingly, the selectors 144_2-144_4 are set to always select 16-bit parallel data from the rate converter 142.

It is to be noted that when the CDR 120_1 determines the input signal to be OC-48, the setting can be changed so that the selector 144 automatically selects the 16-bit parallel data from the rate converter 142.

Similarly, the CDR 120_1 in each of the input processors 101_2-101_4 extracts the clock from the received OC-12 SONET signal (622 Mbps), and recovers the SONET signal. The S/P converter 130_1 converts the SONET signal to be converted into the 16-bit parallel SONET signal. The transmission rate per bit at this time is 39 Mbps (≈622 Mbps÷16).

The SONET receiving processor 141 performs processing such as a frame synchronization, an OH termination, descrambling, and an error detection.

The rate converter 142 provides the 16-bit parallel SONET signal to the clock changer 145_1 at the same transmission rate.

Similarly, the CDR's 120_2-120_4 in each of the input processors 101_2-101_4 respectively extract the clock 700 from the received OC-12 SONET signal (622 Mbps), and recover the SONET signal 750. The S/P converters 130_2-130_4 respectively convert the SONET signal 750 into an 8-bit parallel SONET signal. The transmission rate per bit at this time is 78 Mbps (≈622 Mbps÷8).

The SONET receiving processors 141_2-142_4 perform processing such as a frame synchronization, descrambling, an OH termination, and an error detection.

The S/P converters 143_2-143_4 convert an 8-bit parallel SONET signal into a 16-bit parallel SONET signal. The transmission rate per bit at this time is 39 Mbps (≈78 Mbps÷2). The selectors 144_2-144_4 are respectively set to select the output data from the S/P converters 143_2-143_4.

Accordingly, the 16-bit parallel SONET signals outputted from the S/P converters 143_2-143_4 are respectively provided to the clock changers 145_2-145_4.

It is to be noted that the above-mentioned operation is performed in synchronization with the clock 700 extracted at each CDR 120.

In the input processors 101_1-101_4, each clock changer 145 provides the 16-bit parallel SONET signal inputted to the time division multiplexing portion 146 in synchronization with the master clock 155 MHz within the time division multiplexer. Thus, the OC-48 SONET signal on a single line and the OC-12 SONET signals on 12 lines inputted to the time division multiplexer are provided to the time division multiplexing portion 146 respectively in the form of the 4×16-bit parallel SONET signal and the 16-bit parallel SONET signal.

Namely, 256-bit (=16 bits×4+16 bits×4×3) parallel data are provided to the time division multiplexing portion 146 at the transmission rate of 39 Mbps.

The time division multiplexing portion 146 time division bit multiplexes the inputted data into the 64-bit parallel data of the transmission rate 155 Mbps. Hereinafter, the verb “time division bit multiplex” will be occasionally abbreviated as --bit multiplex--. The FEC encoder 150 mounts the 64-bit parallel data time division multiplexed on information field of the 64-bit parallel FEC frame. The transmission rate per bit of the FEC frame is 167 Mbps which is faster than 155 Mbps, since an overhead or the like is added.

The P/S converter 160 parallel/serial converts (hereinafter, sometimes simply referred to as converts) the FEC frame at a ratio of 64:1 to be outputted. The transmission rate of the output signal is 10.7 Gbps (≈167 Mbps×64) which is slightly faster than the transmission rate of OC-192, 10 Gbps.

Thus, a single OC-48 SONET signal and 12 OC-12 SONET signals are transmitted by simple processing of being mounted on the information field of the FEC frame after simply being bit multiplexed, different from the usual multiplexing processing of the SONET signal, i.e. the processing of performing the multiplexing of an overhead byte, byte multiplexing of data (payload), a recognition of a data head, or the like.

Also, by using the CDR, even if any of the e.g. OC-48, OC-12, and OC-3 signals is inputted, it can be received, commonality can be provided among the O/E converter and the CDR, and preparing a package for each transmission rate in the opposite device becomes unnecessary. Thus, universalization is realized.

Also, in the LSI 140 in FIG. 1, a signal rate of an input/output pin (hereinafter, occasionally referred to as I/O pin) is changed according to each input bit rate, whereby it becomes unnecessary to provide the I/O pin for each bit rate, and the number of pins can be reduced.

The case where the time division multiplexer 100 in FIG. 1 multiplexes the OC-12 SONET signal on a single line and the OC-3 SONET signals (155 Mbps) on 12 lines respectively, instead of e.g. the OC-48 SONET signals (2.4 Gbps) on a single line and the OC-12 SONET signals (622 Mbps) on 12 lines in the above-mentioned embodiment, into the FEC frame of 2.7 Gbps will now be briefly described.

In the input processor 101_1, the OC-12 SONET signal on a single line received at the CDR 120_1 is converted into the 8-bit parallel SONET signal (transmission rate per bit: 78 Mbps (≈622 Mbps÷8)) at the S/P converter 130_1. After the SONET signal is received and processed at the SONET receiving processor 141_1, the rate converter 142 converts the SONET signal into a 32-bit parallel SONET signal (transmission rate per bit: 19 Mbps (≈78 Mbps÷4)).

This 32-bit parallel SONET signal is provided to the time division multiplexing portion 146 through only the clock changer 145_1, or respectively through the selectors 144_2-144_4 and the clock changers 145_2-145_4.

In the input processors 101_2-101_4, the OC-3 SONET signals on 12 lines received at the CDR's 120_1-120_4 are respectively converted into the 8-bit parallel SONET signals (transmission rate per bit: 19 Mbps (≈155 Mbps÷8)) at the S/P converters 130_1-130_4. After the SONET signals are received and processed at the SONET receiving processors 141_1-141_4, the SONET signals are directly provided to the clock changer 145_1 and to the clock changers 145_2-145_4 through the selectors 144_2-144_4 without being converted at the rate converter 142 and the S/P converters 143_2-143_4, as the 8-bit parallel SONET signal.

As a result, the time division multiplexing portion 146 receives 128 (=32+8×12)-bit parallel data whose transmission rate per bit is 19 Mbps.

The time division multiplexing portion 146 bit multiplexes the 128-bit parallel data into 16-bit parallel data whose transmission rate per bitis 155 Mbps (≈19 Mbps×128÷16).

The FEC encoder 160 mounts the 16-bit parallel data on the information field of a 16-bit parallel FEC frame. The transmission rate per bit of the FEC frame is 167 Mbps. The P/S converter 160 converts the 16-bit parallel FEC frame into a serial FEC frame of the transmission rate 2.7 Gbps (≈167 Mbps×16).

Thus, the time division multiplexer 100 bit multiplexes the OC-12 SONET signal on a single line and the OC-3 SONET signals on 12 lines inputted into the FEC frame of 2.7 Gbps corresponding to OC-48.

The more detailed operation of the above-mentioned SONET receiving processor 141 and the FEC encoder 150 will now be described.

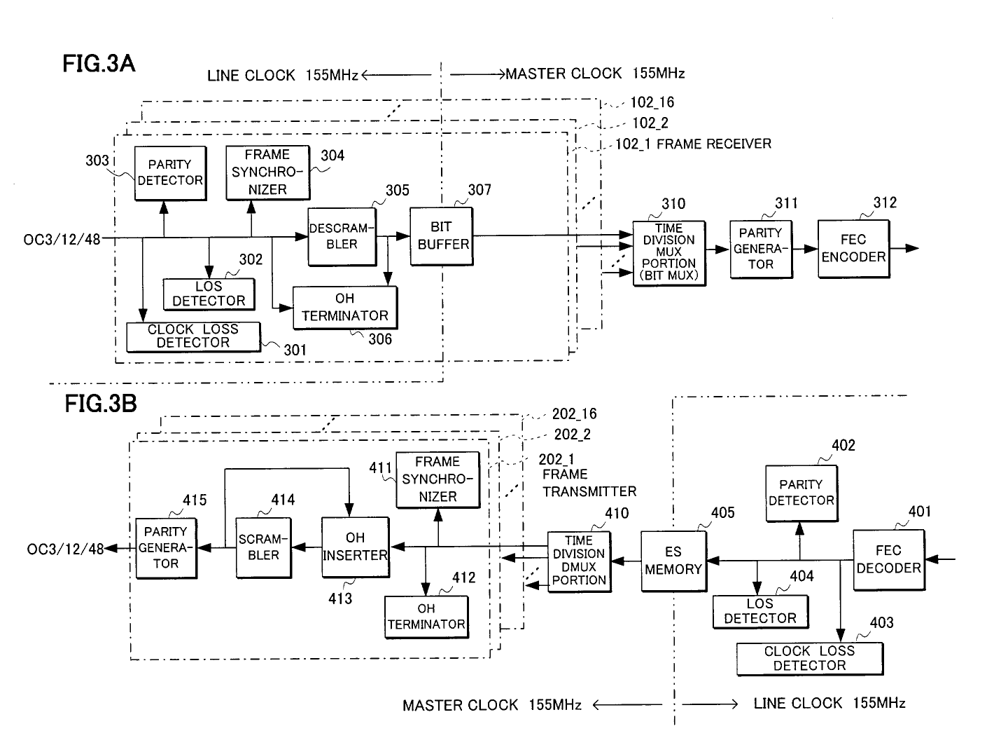

FIG. 3A shows an arrangement of the time division multiplexer 100 in the same way as FIG. 1. In this arrangement, the processing operation of the SONET receiving processor 141 within the LSI 140 shown in FIG. 1 is specifically shown in detail, and the other processing operation is omitted or simplified.

Frame receivers 102_1-102_4, . . . , 102_13-102_16 (hereinafter, occasionally represented by a reference numeral 102) respectively correspond to the input processors 101_1, . . . , 101_4 shown in FIG. 1. Namely, the frame receiver 102 corresponds to a portion for processing the SONET signal on a single line within the input processor 101_1.

Also, a time division multiplexing portion 310 corresponds to the time division multiplexing portion 146 in FIG. 1. A parity generator 311 and an FEC encoder 312 correspond to the FEC encoder 150 and the P/S converter 160.

The frame receiver 102 is composed of a clock loss detector 301, an LOS detector 302, a parity detector 303, a frame synchronizer 304, a descrambler 305, an overhead terminator 306, and a bit buffer 307.

The clock loss detector 301 corresponds to the lock detector 129 (see FIG. 2) within the CDR 120 shown in FIG. 1, and detects the failure of the line clock extraction. The frame synchronizer 304, based on the extracted clock, performs the synchronization of the SONET signal frame. When detecting a SONET signal disconnection due to a failure of a clock extraction, not-yet-transmission of the SONET signal, or the like, the LOS detector 302 outputs the LOS signal indicating the detection.

The parity detector 303 performs a parity check of a frame before descrambling. The descrambler 305 descrambles a predetermined field of the frame to provide the SONET frame unchanged to the bit buffer 307.

The overhead terminator 306 terminates e.g. B1 byte within the overhead after descrambling to be compared with the parity check result at the parity detector 303.

The bit buffer 307 corresponds to the clock changer 145 in FIG. 1, sequentially reads in the SONET frame in synchronization with the line clock 155 MHz, and sequentially reads out the SONET frame in synchronization with the master clock 155 MHz.

Each bit buffer 307 in the frame receivers 102_1-102_16 provides the SONET frame to the multiplexing portion 310. The time division multiplexing portion 310 bit multiplexes the SONET frame from each bit buffer 307 to be provided to the parity generator 311. The FEC encoder 312 mounts the time division multiplexed SONET frame on the FEC frame to be outputted.

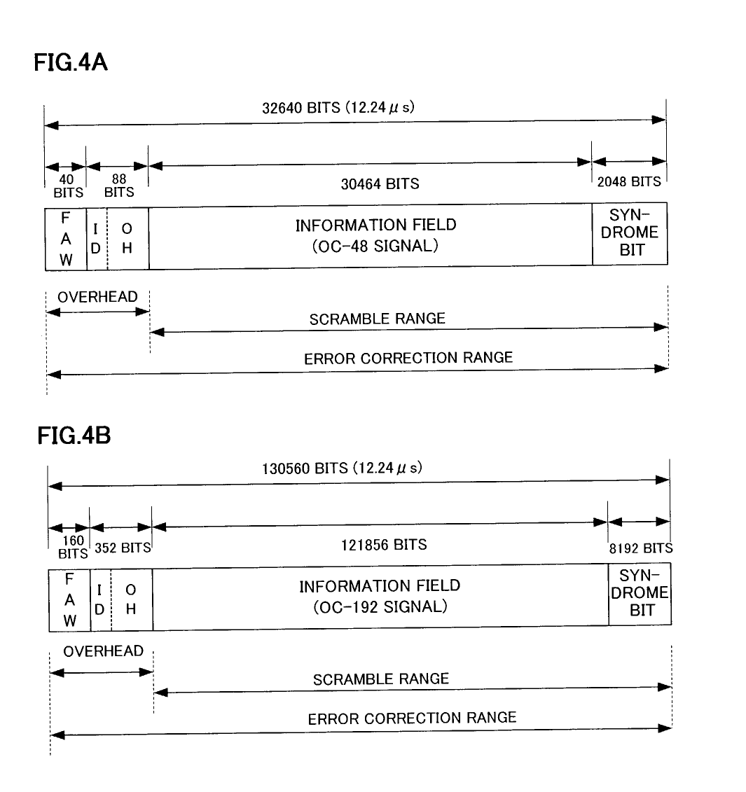

FIGS. 4A and 4B show a format of the FEC frame. FIG. 4A shows the FEC frame for transmitting the data of 2.4 Gbps, and FIG. 4B shows the FEC frame for transmitting the data of 10 Gbps. Hereinafter, the frames shown in FIGS. 4A and 4B are occasionally referred to as a 2.4 Gbps FEC frame and a 10 Gbps FEC frame, respectively.

Both of the 2.4 Gbps frame and the 10 Gbps FEC frame are composed of an overhead field comprising a synchronization field FAW (Frame Alignment Word), an identification field ID, a field OH, an information field, and a syndrome bit field. Its temporal frame length=12.24 μs.

The number of all bits of the 2.4 Gbps FEC frame is 32640 bits, and the number of all bits of the 10 Gbps FEC frame is 130560 bits, that is four times the number of all bits of the 2.4 Gbps FEC frame. Accordingly, the bit rates of the 2.4 Gbps FEC frame and the 10 Gbps FEC frame are respectively 2.666 Gbps and 10.66 Gbps.

The numbers of bits of the synchronization field FAW, the identification field ID, the field OH, the information field, and the syndrome bit field in the 2.4 Gbps FEC frame are respectively 40, 8, 80, 32640, 2048 bits. The numbers of bits of the fields in the 10 Gbps FEC frame are respectively 160, 32, 352, 121856, 8192 bits, which are four times those of the fields in the 2.4 Gbps FEC frame.

In case of A1=“11110110” and A2=“00101000”, the synchronization field FAW of the 2.4 Gbps FEC frame is “A1, A1, A2, A2, A2” or “A1, A1, A1, A2, A2”.

The synchronization field FAW of the 10 Gbps FEC frame is “A1, A1, A1, A1, A1, A1, A1, A1, A2, A2, A2, A2, A2, A2, A2, A2, A2, A2, A2, A2” or “A1, A1, A1, A1, A1, A1, A1, A1, A1, A1, A1, A1, A2, A2, A2, A2, A2, A2, A2, A2”.

A scramble range of the 2.4 Gbps FEC frame and the 10 Gbps FEC frame includes the information field and the syndrome bit field. An error correction range includes all of the frame. For an error correction code, a Reed-Solomon code [255, 239] is used.

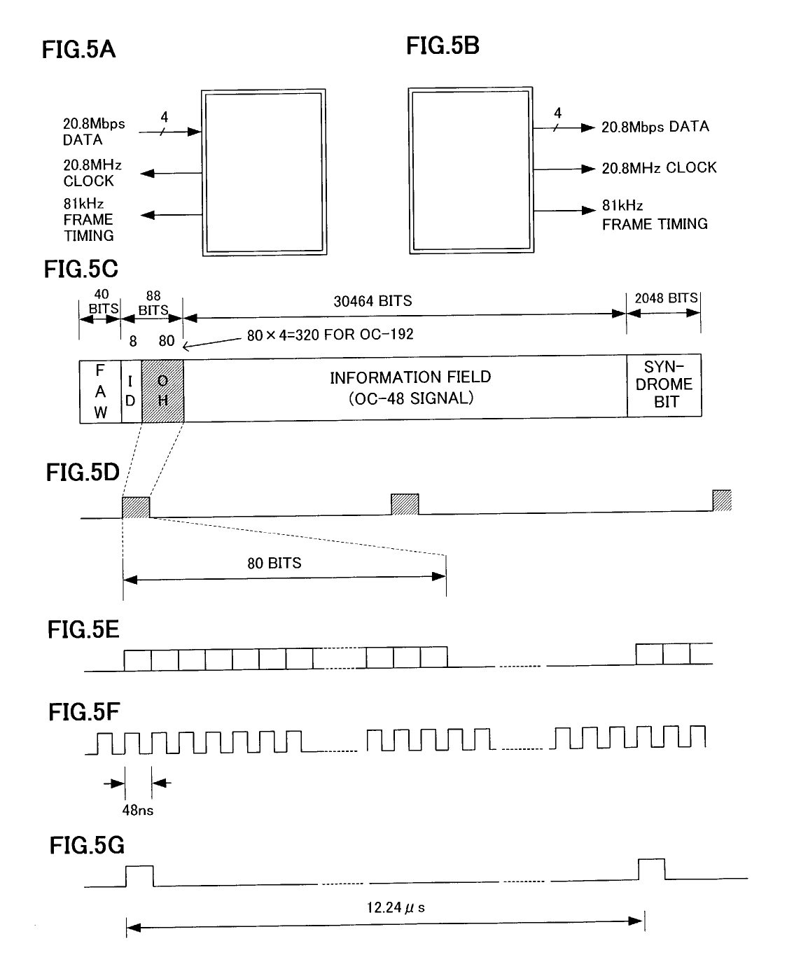

FIGS. 5A-5G show an example of an overhead interface of the FEC frame.

FIG. 5A shows an interface on the FEC encode side, where data of 20.8 Mbps are inputted, and a clock signal of 20.8 MHz and a frame timing signal of 81 kHz are outputted. FIG. 5B shows an interface on the FEC decode side, where the data of 20.8 Mbps are outputted, and the clock signal of 20.8 MHz and the frame timing signal of 81 kHz are outputted.

FIG. 5C shows the 2.4 Gbps FEC frame shown in FIG. 4A. FIG. 5D and FIG. 5E show an output timing of the 20.8 Mbps data, in which the data are outputted after the overhead of 80 bits.

FIG. 5F shows a timing of the 20.8 MHz clock signal, in which a clock interval is 48 ns. FIG. 5G shows the 81 kHz frame timing signal, and the clock interval is 12.24 μs.

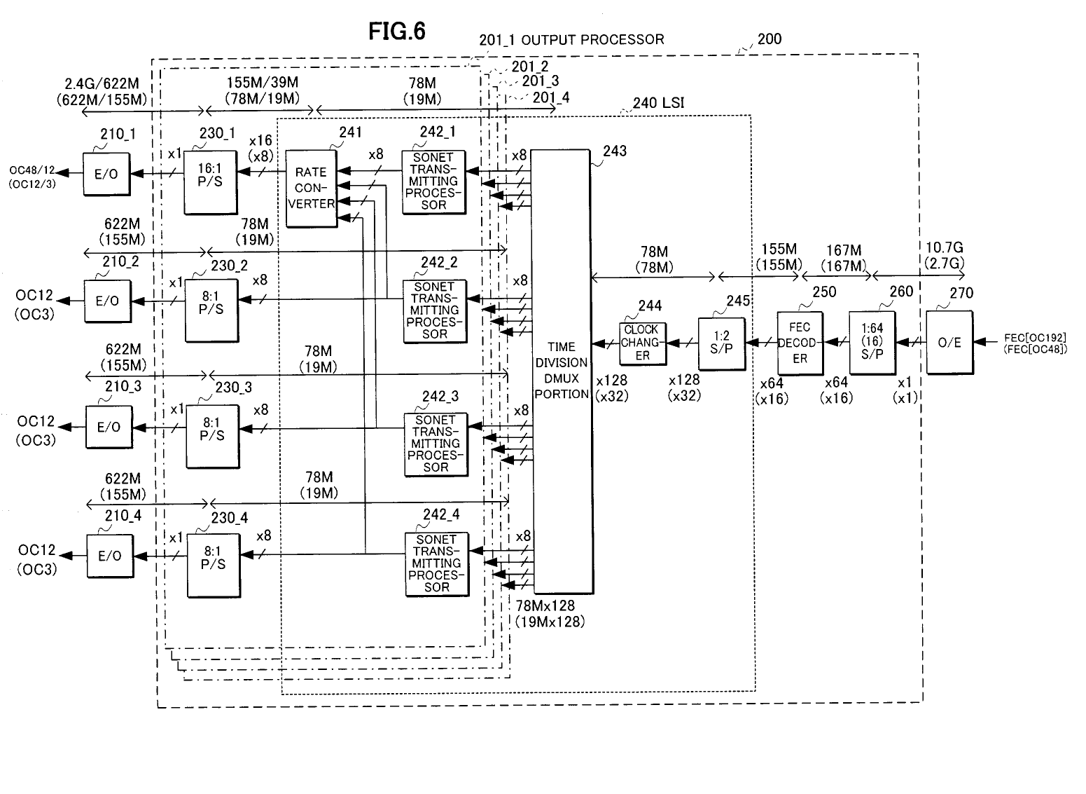

FIG. 6 shows an embodiment of a time division demultiplexer 200 of the present invention. This time division demultiplexer 200 demultiplexes time division multiplexed OC-48 and OC-12 SONET signals mounted on the FEC frame transmitted from the time division multiplexer 100 shown in FIG. 1 into the original OC-48 or OC-12 SONET signals.

The time division demultiplexer 200 is composed of an S/P converter 260 at a ratio of 1:64, an FEC decoder 250, an S/P converter 245 at a ratio of 1:2, a clock changer 244, a demultiplexing portion 243, and output processors 201_1-201_4 (hereinafter, occasionally represented by a reference numeral 201).

Each of the output processors 201 is composed of SONET transmitting processors 242_1-242_4, a rate converter 241, a P/S converter 230_1 at a ratio of 16:1, and P/S converters 230_2-230_4 (hereinafter, occasionally represented by a reference numeral 230) at a ratio of 8:1.

It is to be noted that the rate converter 241, the SONET transmitting processors 242_1-242_4, the time division demultiplexing portion 243, the clock changer 244, and the S/P converter 245 in each of the output processors 201_1-201_4 are composed of a single LSI 240.

The time division demultiplexer 200 receives the FEC frame converted by an O/E converter 270. Also, the OC-12 or OC-3 SONET signal transmitted from the time division demultiplexer 200 is converted by E/O converters 210_1-210_16 (E/O converters 210_5-210_16 are not shown in FIG. 6).

The operation of the time division demultiplexer 200 will now be described in case where the FEC frame (time division multiplexed OC-48 SONET signals on a single line and OC-12 SONET signals on 12 lines) of 10 Gbps transmitted in FIG. 1 is received.

While the transmission rate and the number of parallel bits of the data in the time division demultiplexer in case where the time division demultiplexer 200 receives the FEC frame of 10 Gbps are shown in FIG. 6, the transmission rate and the number of parallel bits of the data in the time division demultiplexer in case where the 2.4 Gbps FEC frame is received are shown within the parentheses in FIG. 6.

The S/P converter 260 converts the FEC frame of the received serial data into 64-bit parallel FEC data. The transmission rate per bit at this time is 167 Mbps (≈10.7 Gbps÷64).

The FEC decoder 250 terminates the FEC frame received in the form of the 64-bit parallel data, namely performs an extraction of a clock, descrambling, a frame synchronization, an error correction, a read of data (information bit), and outputs the 20.8 Mbps data (64-bit parallel data), the 20.8 MHz clock, and the 81 kHz frame timing signal shown in FIG. 5B. The transmission rate per bit of the data at this time is 155 Mbps.

The S/P converter 245 converts the 64-bit parallel data into 128-bit parallel data. The transmission rate per bit of the data at this time is 78 Mbps (≈155 Mbps÷2). The clock changer 244 changes the 128-bit parallel data from the line clock to the master clock on the time division demultiplexer side.

The time division demultiplexing portion 243 performs demultiplexing or reversing the multiplexing performed by the time division multiplexing portion 146 in FIG. 1, to the 128-bit parallel data, provides the 32-bit parallel OC-48 SONET signal on a single line to the output processor 201_1, and provides the 8-bit parallel OC-3 SONET signals on 4 lines respectively to the output processors 201_2-201_4. The transmission rate per bit at this time is 78 Mbps (≈78 Mbps×128÷128).

While the time division demultiplexing portion 243 recognizes the contents of the SONET signal based on the FEC frame in this way, only a simple time division bit demultiplexing is performed and it is not necessary to perform the demultiplexing of the overhead byte, the byte demultiplexing, a head recognition of data, or the like with the recognition of the SONET format.

The SONET transmitting processors 242_1-242_4 in the output processor 201_1 respectively receive 16 bits within the 32-bit parallel OC-48 SONET signal from the demultiplexing portion 243. The SONET transmission processing of the signal, e.g. scrambling, the parity generation after scrambling, or the like is performed by all of the processors 242_1-242_4 to be provided to the rate converter 241.

The rate converter 241 converts the transmission rate of the 32-bit parallel SONET signal received (transmission rate per bit is 78 Mbps) into a 16-bit parallel SONET signal of 155 Mbps per bit (≈78 Mbps×32÷16).

The P/S converter 230_1 converts the 16-bit parallel data SONET signal of 155 Mbps into 2.4 Gbps (≈155 Mbps×16) serial data.

The rate converter 241 in each of the output processors 201_2-201_4 is preset to provide a signal only from the SONET transmitting processor 242_1 to the P/S converter 230_1. The P/S converter 230_1 is preset to perform a serial/parallel conversion at a ratio of 8:1.

The SONET transmitting processors 242_1-242_4 in each of the output processors 201_2-201_4 respectively perform transmission processing of the 8-bit parallel OC-12 SONET signal received. The P/S converters 230_1-230_4 respectively convert the 8-bit parallel OC-12 SONET signal (transmission rate per bit: 78 Mbps) into a serial OC-12 SONET signal (transmission rate: 622 Mbps≈78 Mbps×8) to be outputted.

Thus, the OC-48 SONET signal on a single line and the OC-12 SONET signals on 12 lines, which the time division multiplexer 100 (see FIG. 1) has transmitted to the FEC frame by time division multiplexing, are recovered at the time division demultiplexer 200 to be outputted.

It is to be noted that in the LSI 240 of FIG. 6, the signal rate of the I/O pin is changed in accordance with each input bit rate, whereby it becomes unnecessary to provide the I/O pin per bit rate, and the number of pins can be reduced.

FIG. 3B shows an arrangement of the time division demultiplexer 200 in the same way as FIG. 6. In this arrangement, the processing operation of the SONET transmitting processor 242 and the FEC decoder 250 within the LSI 240 shown in FIG. 6 is specifically shown in detail and the other processing operation is simplified or omitted.

An FEC decoder 401, a parity detector 402, a clock loss detector 403, and an LOS detector 404 in FIG. 3B correspond to the S/P converter 260 at a ratio of 1:16, the FEC decoder 250, the S/P converter 245 at the ratio of 1:2 in FIG. 6. An elastic store memory 405 and a time division demultiplexing portion 410 in FIG. 3B respectively correspond to the clock changer 244 and the time division demultiplexing portion 243 in FIG. 6.

Also, frame transmitters 202_1-202_16 (hereinafter, occasionally represented by a reference numeral 202) in FIG. 3B respectively correspond to the SONET transmitting processors 242_1-242_4 of the output processor 201_1, . . . , and the SONET transmitting processors 242_1-242_4 of the output processor 201_4 in FIG. 6.

The FEC decoder 401 in FIG. 3B terminates the FEC frame to which a parity bit (syndrome bit) is added and scrambled at the FEC encoder 312 in FIG. 3A. The clock loss detector 403 detects the failure of the line clock extraction, and the LOS detector 404 detects the input signal disconnection, and the parity detector 402 detects or corrects a code error.

The elastic store memory 405 changes the OC-48 and OC-12 data from the FEC decoder 401 from the line clock 155 MHz to the master clock 155 MHz to be provided to the time division demultiplexing portion 410.

The time division demultiplexing portion 410 demultiplexes corresponding to the time division multiplexing in FIG. 3A, and provides the demultiplexed frame to the frame transmitter 202.

In the frame transmitter 202, the frame synchronizer 411 performs a frame synchronization of the SONET signal, and the OH terminator 412 terminates the overhead. The OH inserter 413 inserts the overhead into the frame, and the scrambler 414 scrambles a predetermined field of the frame. The parity generator 415 generates the parity of the frame after scrambling to be written in the overhead.

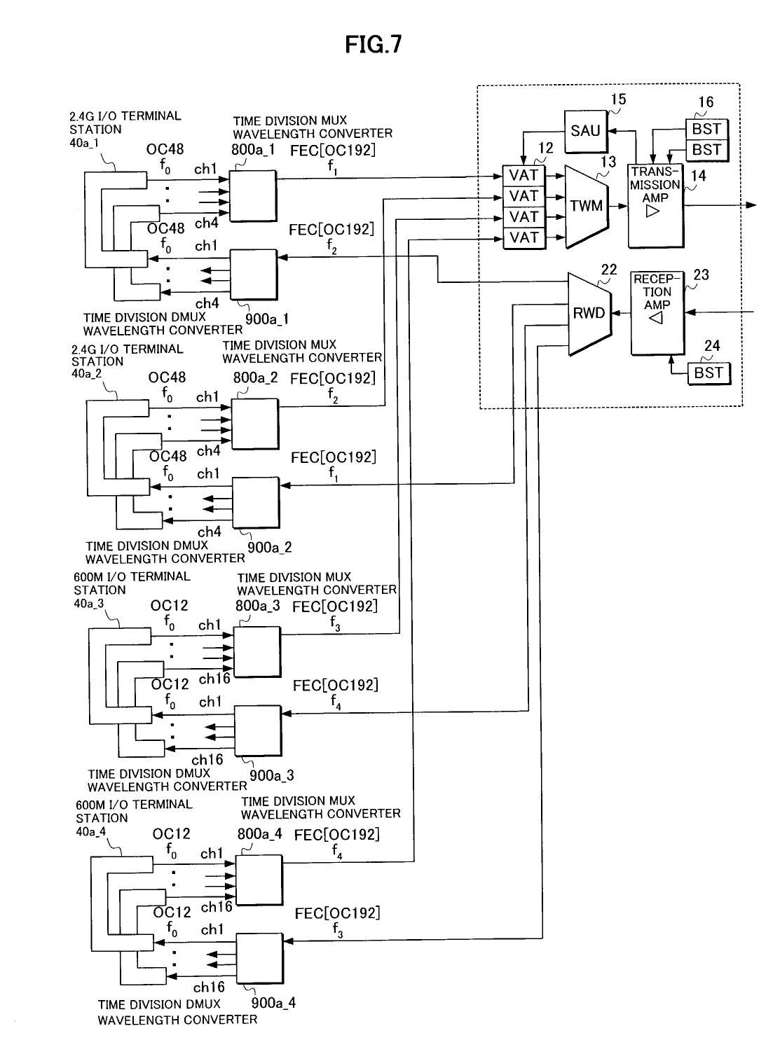

FIG. 7 shows an embodiment of a wavelength division multiplexing system using a time division multiplexing wavelength converter 800a and a time division demultiplexing wavelength converter 900a respectively using the above-mentioned time division multiplexer 100 and the time division demultiplexer 200.

In FIG. 7, 2.4 G input/output terminal stations (hereinafter, occasionally referred to as I/O terminal stations) 40a_1 and 40a_2 respectively transmit the optical OC-48 SONET signals through lines ch1-ch4 to time division multiplexing wavelength converters 800a_1 and 800a_2 with a wavelength f0. 600M I/O terminal stations 40a_3 and 40a_4 respectively transmit the optical OC-12 SONET signals through lines ch1-ch16 to time division multiplexing wavelength converters 800a_3 and 800a_4 with the wavelength f0.

The arrangement of the time division multiplexing wavelength converters 800a_1-800a_4 (hereinafter, occasionally represented by a reference numeral 800a) corresponds to that shown in FIG. 1 where the O/E converters 110_1-110_16 are added to the input side of the time division multiplexer 100 and the E/O converter 170 (see FIG. 1) is added to the output side.

It is to be noted that the E/O converters 170 of the time division multiplexing wavelength converters 800a_1-800a_4 are supposed to be able to respectively set the wavelengths of the optical output signals e.g. to different wavelengths f1, f2, f3, and f4.

In the time division multiplexing wavelength converters 800a_1 and 800a_2, the CDR's 120_1 (see FIG. 1) of the input processors 101_1-101_4 receive the OC-48 SONET signals from lines ch1-ch4 respectively through the O/E converters 110_1, 110_5, 110_9, and 110_13 (O/E converters 110_5, 110_9, and 110_13 are not shown), bit multiplex these OC-48 frames on 4 lines, and mount the same on the 10 Gbps FEC frame corresponding to the transmission rate of OC-192 to be outputted.

In the time division multiplexing wavelength converters 800a_3 and 800a_4, the CDR's 120_1-120_4 of the input processors 101_1-101_4 respectively receive the OC-12 SONET signals from lines ch1-ch16 through the O/E converters 110_1-110_16 (O/E converters 110_5-110_16 are not shown), bit multiplex these OC-12 frames from 16 lines, and mount the same on the 10 Gbps FEC frame corresponding to the transmission rate of OC-192 to be outputted.

Thus, the time division multiplexing wavelength converter 800a can accommodate to the different transmission rates, e.g. OC-48 or OC-12 in the same arrangement. Furthermore, the time division multiplexing wavelength converter 800a can be connected to an I/O terminal station 40 with lines ch1-ch13, receive e.g. the OC-48 SONET signal from the line ch1 and the OC-12 SONET signals from the lines ch2-ch13 as shown in the embodiment of FIG. 1, and multiplex the same into the FEC frame corresponding to the OC-192.

Namely, it is possible to receive the SONET signals of different transmission rates from the same I/O terminal station 40a, and to multiplex the same into the FEC frame.

The FEC frames that are time division multiplexed OC-48 frames or OC-12 frames corresponding to the rate of the OC-192 frames outputted from the time division multiplexing wavelength converters 800a_1-800a_4 are converted into frames of wavelengths f1-f4 different from each other to be outputted. Then, the outputted frames are provided to a wavelength division multiplexer 13 through a VAT 12.

The SONET signals of the wavelengths f1-f4 are wavelength division multiplexed at the wavelength division multiplexer 13 to be provided to a wavelength division demultiplexer 22 through a transmission amplifier 14, and e.g. a reception amplifier 23. The wavelength division demultiplexer 22 demultiplexes the signal into the SONET signals of the wavelengths f1-f4.

For example, the SONET signals of the wavelengths f1-f4 are respectively inputted to time division demultiplexing wavelength converters 900a_2, 900a_1, 900a_4, and 900a_3.

The arrangement of the time division demultiplexing wavelength converters 900a_1-900a_4 is that shown in FIG. 6 where the O/E converter 270 is added to the input side of the time division demultiplexer 200 and the E/O converters 210_1-210_16 (see FIG. 6; E/O converters 210_5-210_16 are not shown) are added to the output side.

The time division demultiplexing wavelength converter 900a_2 converts the received optical FEC frame of the wavelength f1 into an electrical signal, and demultiplexes the OC-48 SONET signals on 4 lines that are bit multiplexed and mounted on the FEC frame. Furthermore, the time division demultiplexing wavelength converter 900a_2 E/O converts the demultiplexed OC-48 SONET signals into the optical SONET signals of the wavelength f0 to be outputted to the lines ch1-ch4. The I/O terminal station 40a_2 receives the OC-48 optical SONET signals on ch1-ch4.

As a result, the OC-48 SONET signals on 4 lines transmitted from the I/O terminal station 40a_1 are received by the I/O terminal station 40a_2. Similarly, it is possible for the I/O terminal station 40a_1 to receive the OC-48 SONET signals on 4 lines transmitted from the I/O terminal station 40a_2.

Also, it is possible for the I/O terminal station 40a_4 to receive the OC-12 SONET signals on 16 lines transmitted from the I/O terminal station 40a_3 and for the I/O terminal station 40a_3 to receive the OC-12 SONET signals on 16 lines transmitted from the I/O terminal station 40a_4.

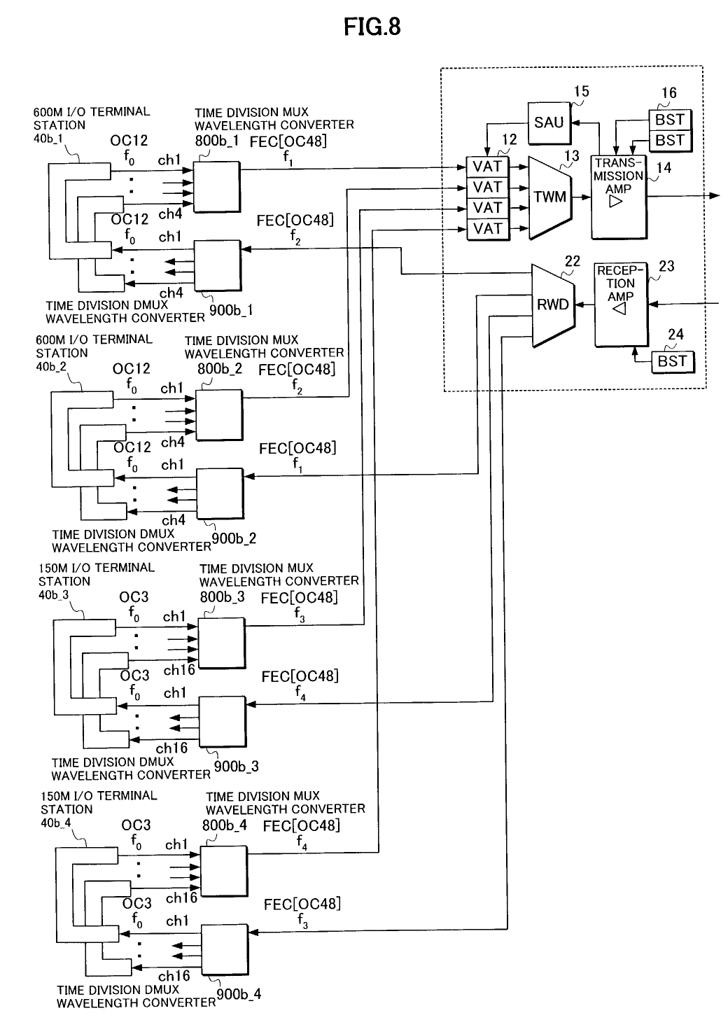

FIG. 8 shows an embodiment of time division multiplexing wavelength converters 800b_1-800b_4 (hereinafter, occasionally represented by a reference numeral 800b) and time division demultiplexing wavelength converters 900b_1-900b_4 using the time division multiplexer 100 and the time division demultiplexer 200 respectively shown in FIGS. 1 and 6 in the same way as FIG. 7.

These time division multiplexing wavelength converters 800b and the time division demultiplexing wavelength converters 900b are different from the time division multiplexing wavelength converters 800a and the time division demultiplexing wavelength converters 900a shown in FIG. 7 in that the SONET signals which can be processed are not set to OC-48 nor OC-12, but to OC-12 and OC-3, and the basic arrangement is the same.

Also, the network arrangement of FIG. 8 is the same as that of FIG. 7 except the following point: The I/O terminal stations 40b_1 and 40b_2 in FIG. 8 correspond to 600 Mbps and the I/O terminal stations 40b_3 and 40b_4 correspond to 150 Mbps, different from the I/O terminal stations 40a_1-40a_2 of 2.4 Gbps and the I/O terminal stations 40a_3-40a_4 of 600 Mbps in FIG. 7.

The time division multiplexing wavelength converters 800b_1 and 800b_2 and the time division demultiplexing wavelength converters 900b_1 and 900b_2 respectively transmit/receive the OC-12 SONET signals to/from the I/O terminal stations 40b_1 and 40b_2 with the lines ch1-ch4. The time division multiplexing wavelength converters 800b_3 and 800b_4, and the time division demultiplexing wavelength converters 900b_3 and 900b_4 respectively transmit/receive the OC-3 SONET signals to/from the I/O terminal stations 40b_3 and 40b_4 with lines ch1-ch16.

The operations of the time division multiplexing wavelength converters 800b_1-800b_4, and time division demultiplexing wavelength converters 900b_1-900b_4 in FIG. 8 are the same as those of the time division multiplexing wavelength converters 800a_1-800a_4, and the time division demultiplexing wavelength converters 900a_1-900a_4 in FIG. 7.

As described above, a time division multiplexer according to the present invention is arranged such that a time division multiplexing portion converts a plurality of frames having the first format into time division multiplexed data, and an encoder mounts the data on frames of the second format to be outputted to a single line. A time division demultiplexer according to the present invention is arranged such that a decoder decodes the frames from the time division multiplexer, and a time division demultiplexing portion demultiplexes a plurality of frames of the first format from the data. Since overhead processing of the first frame, i.e. operational processing such as an alarm generation state indication and a transmission line switchover control is not performed, the circuit can be downsized.

When the first format is e.g. a SONET format, only the required minimum processing not in accordance with the SONET format is performed, thereby enabling the circuit to be simplified.

Also, the time division multiplexer is arranged such that a clock/data recovery portion receives frames of different predetermined transmission rates and recovers a clock and data to be outputted to the time division multiplexing portion. Therefore, it becomes possible for the time division multiplexer to accommodate to the frames of the first format whose transmission rates are different from each other, and to provide commonality among the frames whose transmission rates are different from each other. As a result, the number of pins can be reduced by a commonality of I/O pins, and an LSI downsizing and a low-priced LSI can be achieved.

Also, a time division multiplexing wavelength converter of the present invention is arranged by adding an O/E converter and an E/O converter respectively at the former stage and the subsequent stage of the time division multiplexer of the above-mentioned present invention so that the E/O converter converts an electrical signal into an optical signal whose wavelength is different from that of the optical signal on the input side. A time division demultiplexing wavelength converter of the present invention is arranged by adding an O/E converter and an E/O converter respectively at the former stage and the subsequent stage of the time division demultiplexer of the above-mentioned present invention so that the E/O converter converts an electrical signal into an optical signal whose wavelength is different from that of the optical signal on the input side. Therefore, it becomes possible for a wavelength division multiplexing system to perform wavelength division multiplexing at the maximum transmission rate.

Namely, by adding a time division multiplexing/demultiplexing function to the wavelength converter, and reducing the time division multiplexer/demultiplexer connected to an I/O terminal station, a low-priced system can be realized. Also, it becomes unnecessary for the input terminal station to make the optical signal transmitted to the wavelength division multiplexer the maximum transmission rate.

What we claim is:

1. A time division multiplexer comprising:
a time division multiplexing portion for converting frames having a first format respectively received from a plurality of lines into time division multiplexed data; and
an encoder for mounting the data on one or more frames of a second format to be outputted to a single line.

2. The time division multiplexer as claimed in claim 1 wherein the first format comprises an SDH/SONET format.

3. The time division multiplexer as claimed in claim 1 wherein the second format comprises an FEC format.

4. The time division multiplexer as claimed in claim 1 wherein the multiplexing comprises bit multiplexing.

5. The time division multiplexer as claimed in claim 1, further comprising a clock/data recovery portion for receiving frames of different predetermined transmission rates and for recovering a clock and data to be outputted to the time division multiplexing portion.

6. The time division multiplexer as claimed in claim 1 wherein the first format has a hierarchized format so that the frames of different hierarchies coexist.

7. The time division multiplexer as claimed in claim 1, further comprising a receiving processor for performing an error detection, an error correction, or descrambling of the frames of the first format.

8. A time division demultiplexer comprising:
a decoder for decoding frames having a second format on which time division multiplexed data of a plurality of frames having a first format are mounted; and
a time division demultiplexing portion for time division demultiplexing a plurality of frames of the first format from the data.

9. The time division demultiplexer as claimed in claim 8 wherein the first format comprises an SDH/SONET format.

10. The time division demultiplexer as claimed in claim 8 wherein the second format comprises an FEC format.

11. The time division demultiplexer as claimed in claim 8 wherein the time division multiplexing comprises bit multiplexing.

12. A time division multiplexing wavelength converter comprising:
a plurality of O/E converters for converting frames, which are predetermined wavelength optical signals having a first format, respectively received from a plurality of lines into electrical signals respectively;
a time division multiplexing portion for converting a plurality of frames of the electrical signals into time division multiplexed data;
an encoder for mounting the data on one or more frames of a second format to be outputted to a single line; and
an E/O converter for converting the frames of the second format into optical signals of a wavelength different from the predetermined wavelength.

13. The time division multiplexing wavelength converter as claimed in claim 12, further comprising a clock/data recovery portion for receiving electrical signal frames of different predetermined transmission rates and for recovering a clock and data to be outputted to the time division multiplexing portion.

14. A time division demultiplexing wavelength converter comprising:
an O/E converter for converting, into electrical signals, frames which are predetermined wavelength optical signals having a second format on which time division multiplexed data of a plurality of frames having a first format are mounted;
a decoder for decoding the frames of the second format;
a time division demultiplexing portion for time division demultiplexing a plurality of frames of the first format from the data; and
an E/O converter for converting electrical signals of a plurality of frames of the first format into optical signals of a wavelength different from the predetermined wavelength.
